(19) United States
(12) Patent Application Publication
(10) Pub. No.: US 2016/0319560 A1
(43) Pub. Date: Nov. 3, 2016

(54) COGENERATION PLANT

(71) Applicant: CYCLECT ELECTRICAL ENGINEERING PTE LTD, Singapore (SG)

(72) Inventors: Weng Wah KHONG, Singapore (SG); Hideharu YANAGI, Singapore (SG)

(73) Assignee: CYCLECT ELECTRICAL ENGINEERING PTE LTD, Singapore (SG)

(21) Appl. No.: 15/108,309

(22) PCT Filed: Dec. 23, 2014
(86) PCT No.: PCT/SG2014/000611

§ 371 Date: Jun. 26, 2016

(30) Foreign Application Priority Data
Dec. 26, 2013 (SG) 201309586-4

(51) Int. Cl. E04H 5/02; F02B 43/10; E04H 5/10; F25B 27/02; F25B 15/00; F02B 65/00; F02D 19/06

(52) U.S. Cl. CPC E04H 5/02; F02B 65/00; F02B 43/10; F02D 19/0647; F25B 27/02; F25B 15/00; E04H 5/10; F02B 2043/103; F25B 2500/12; E04H 2005/005

(57) ABSTRACT

There is provided a cogeneration plant unit comprising a base storey housing power generation source; a second storey vertically arranged above the base storey housing absorption chiller, the absorption chiller operable to be in fluid communication with the power generation source; a third storey vertically arranged above the second storey, the third storey houses cooling tower; and a chimney arranged in fluid communication with the power generation source and absorption chiller to dissipate the exhaust of the power generation source and the absorption chiller. The cogeneration plant unit may be further extended to incorporate more elements or form a cogeneration plant suitable for providing electricity, heat and cooling energy to a data centre.

### FIELD OF THE INVENTION

The present invention relates to a cogeneration plant. In particular, the invention relates to a cogeneration plant suitable for, but not limited to the powering and cooling of a data centre and will be described in this context.

### BACKGROUND

The following discussion of the background to the invention is intended to facilitate an understanding of the present invention only. It should be appreciated that the discussion is not an acknowledgement or admission that any of the material referred to was published, known or part of the common general knowledge of the person skilled in the art in any jurisdiction as at the priority date of the invention.

Throughout the specification, unless the context requires otherwise, the word “comprise” or variations such as “comprises” or “comprising”, will be understood to imply the inclusion of a stated integer or group of integers but not the exclusion of any other integer or group of integers.

Furthermore, throughout the specification, unless the context requires otherwise, the word “include” or variations such as “includes” or “including”, will be understood to imply the inclusion of a stated integer or group of integers but not the exclusion of any other integer or group of integers.

Data centres typically utilize more energy than typical commercial buildings, as they require proper cooling facilities to maintain the servers and electrical components. These servers and electrical components ideally should run at twenty-four hours, seven days a week (i.e. 24/7) barring scheduled downtimes and as such, a cogeneration configuration, i.e. production of two forms of usable energy from one fuel source, is a suitable and viable option to power and cool data centres efficiently.

A common cogeneration configuration for data centres would be a gas-powered turbine/engine generator that generates electricity and heat. The electricity powers the equipment and the resulting heat (in the form of flue, hot water etc.) recovered from the turbine generator is then used to run one or more absorption chiller(s) to provide cooling via air-conditioning to the servers and electrical components, for example. Such a configuration where a cogeneration plant produces electricity energy, heat energy, and energy used for cooling simultaneously, is known as tri-generation.

To power data centres, current cogeneration plants require a large amount of physical space to incorporate and house the heavy power generators and/or absorption chillers with foundations. These cogeneration plants may not be applicable for areas or applications where physical space is limited. The need for physical space is further exacerbated, as large absorption chillers are required to produce an adequate level of cooling for the data centres.

Another important consideration for data centres is the need to minimize outages and downtimes. In this regard, standards body such as the Uptime Institute issues certificates to data facilities ranging from tier 1 to 4, with tier 4 data facilities as those certified to have minimum downtime and outages. In addition to meeting general requirements, the design and implementation of cogeneration plants for data centre have to meet as high an Uptime tier standard as possible.

The present invention seeks to provide a cogeneration plant that alleviates the physical space constraint while meeting standard requirements at least in part.

### SUMMARY OF THE INVENTION

It is to be appreciated that the term “cogeneration plant” refers to a plant producing electricity and heat which includes (but is not limited to) a tri-generation plant, where a cogeneration plant produces three types of energy including electricity, heat and energy used for cooling.

In accordance with an aspect of the invention there is a cogeneration plant unit comprising a base storey for housing a power generation source; a second storey vertically arranged above the base storey for housing an absorption chiller, the absorption chiller operable to be in fluid communication with the power generation source; a third storey vertically arranged above the second storey, the third storey for housing a cooling tower; and a chimney arranged in-fluid communication with the power generation source and absorption chiller to dissipate the exhaust of the power generation source and the absorption chiller in operation.

Preferably, the cogeneration plant unit comprises at least one additional storey vertically arranged above the second storey, each of the at least one additional storey for housing an absorption chiller.

Preferably, the cogeneration plant unit comprises a muffler disposed between the base storey and the second storey for housing the absorption chiller(s).

Preferably, the cogeneration plant unit comprises at least one additional storey arranged between the storeys for housing absorption chillers and the third storey, the at least one additional storey for housing electrical components.

Preferably, the power generation source is a dual-fuel reciprocating (piston) engine operable in a mode driven by a combination of natural gas and diesel.

Preferably, the combination of natural gas and diesel comprises at least 90% natural gas.

Preferably, in operation the combination of natural gas and diesel is utilized for a pilot-ignition of the power generation source, and thereafter natural gas is utilized as the single fuel for power generation.

Preferably, the absorption chiller is activated by an input of exhaust (flue gas), and supplemented by hot water.

In accordance with another aspect of the invention there is a cogeneration plant operable to power a data centre, the cogeneration plant comprising a cogeneration plant unit as described in the previous aspect, the cogeneration plant unit having twelve power generation sources and twenty four absorption chillers.

Preferably, each power generation source is a reciprocating (piston) engine having a maximum load capacity of 8.7 megawatts and operable to produce an output at 50% load.

Preferably, each absorption chiller operates to produce 500 refrigeration tons.

Preferably, twelve of the twenty-four absorption chillers are operable each to produce 1000 refrigeration tons and the remaining twelve absorption chillers are not in operation or in stand-by mode.

### BRIEF DESCRIPTION OF THE DRAWINGS

The present invention will now be described, by way of example only, with reference to the accompanying drawings, in which:

FIG. 1 is a schematic diagram of a cogeneration plant unit in accordance with an embodiment of the invention;

FIG. 2 is a schematic diagram of a cogeneration plant unit in accordance with another embodiment of the invention;

FIG. 3 shows a possible operating arrangement having two of the cogeneration units of FIG. 2; and

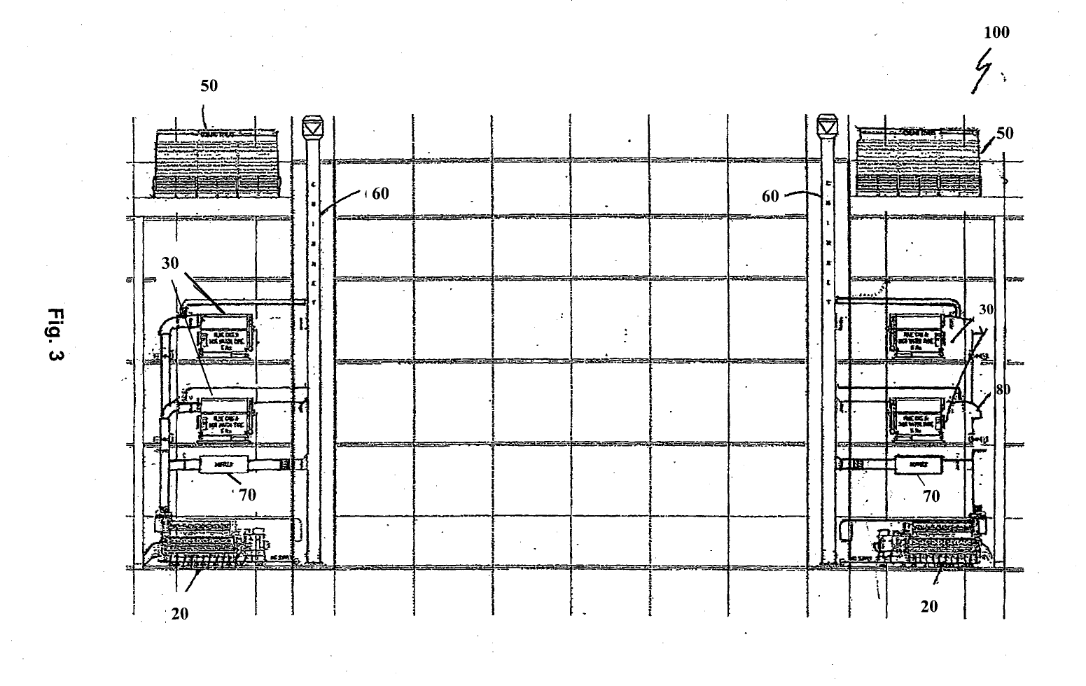

FIG. 4 is a diagram of another embodiment of a cogeneration plant suited for use to power and cool a data centre, the cogeneration plant comprising twelve power generation sources coupled with twenty-four absorption chillers.

Other arrangements of the invention are possible and, consequently, the accompanying drawings are not to be understood as superseding the generality of the preceding description of the invention.

### PREFERRED EMBODIMENTS OF THE INVENTION

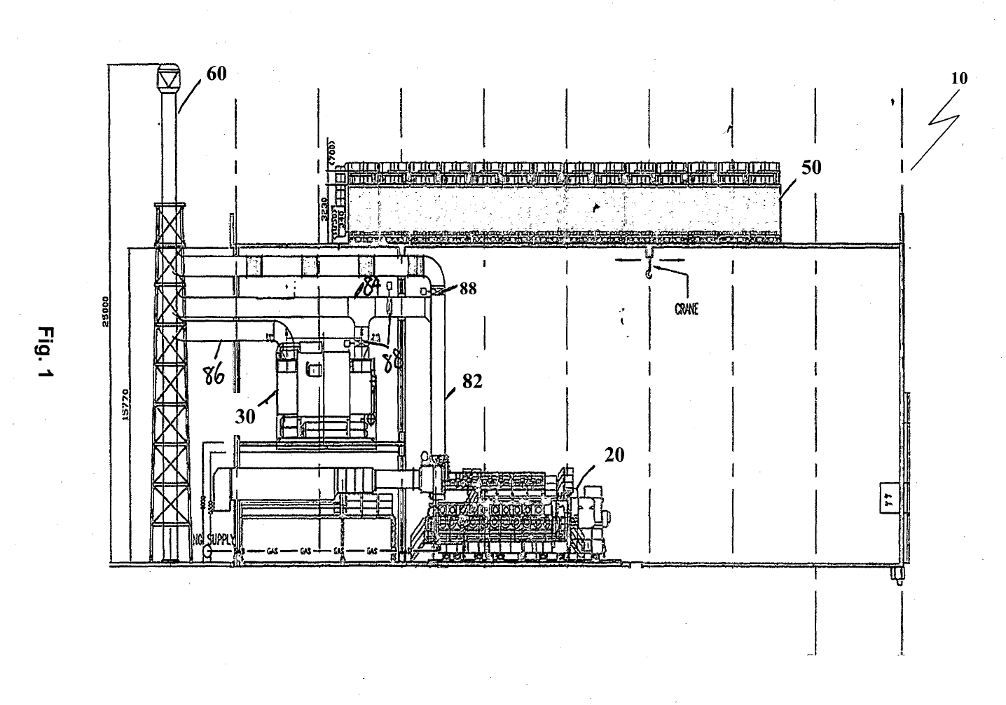

In accordance with an embodiment of the invention and with reference to FIG. 1 there is a cogeneration plant unit 10. The cogeneration plant unit 10 comprises three storeys.

As shown in FIG. 1, cogeneration plant unit 10 comprises a base storey housing a power generation source 20; a second storey vertically arranged above the base storey for housing an absorption chiller 30, the absorption chiller 30 operable to be in fluid communication with the power generation source 20; a third storey vertically arranged above the second storey for housing cooling towers 50; and

a chimney 60 arranged in fluid communication with the power generation source 20 and absorption chiller 30 to dissipate the exhaust of the absorption chiller 30 and the power generation source 20.

One or more muffler(s) 70 may be suitably located (for example between the base and second storeys) to reduce the noise level generated by the power generation source 20. The power generation source 20 may also be housed in an enclosed area (not shown) to further reduce noise and/or protect the power generation source 20 against weather elements.

The power generator 20 is preferably a reciprocating (piston) engine.

Reciprocating (piston) engine 20 is a dual-fuel engine capable of being driven in various modes corresponding to the usage of two different types of fuel.

The two different types of fuel are typically diesel and natural gas. As an example, power generator 20 is driven by a combination of primarily natural gas and a relatively small amount of diesel. Preferably, the combination comprises at least 90% of natural gas. Natural gas is deemed to be a preferred fuel over diesel because the exhaust generated is cleaner and hence better for use as input for the absorption chiller 30.

Each reciprocating engine 20 is configured to have a net electrical output depending on the needs of the application. The reciprocating engine 20 is operable to be in fluid communication, and/or coupled with the absorption chiller 30.

The absorption chiller 30 is operably configured to be activated primarily based on exhaust (flue gas) fired, and supplemented by hot water. The absorption chiller 30 has an operating refrigerating capacity of up to 1000 USRT (refrigeration ton).

The power generator 20 and absorption chiller 30 are connected via exhaust ducting configuration 80.

The exhaust ducting configuration 80 comprises a first duct 82, a second duct 84 and a third duct 86 arranged in the following manner:
The first duct 82 is operable to connect exhaust from the reciprocating engine 20 to the chimney 60. The first duct 82 comprises two ends. One end of the first duct 82 is connected to the reciprocating engine 20 and the other end of the first duct 82 is connected to the chimney 60.
The second duct 84 is operable to divert flue exhaust from the reciprocating engine 20 to the absorption chiller 30 for driving the absorption chiller 30. The second duct 84 comprises a first and a second part, the first part extending from a portion of the first duct 82 at one end and into the input (for flue exhaust) mechanism of the absorption chiller 30 at the other end; and the second part of the second duct 84 is jointed to the first part at one end and connected to the chimney 60 at the other end.
The third duct 86 connects the exhaust of the absorption chiller 30 to the chimney 60 for dissipation.

Valves 88 are located in suitable positions to direct/restrict the flow of fluid (including exhaust) in the first, second and third ducts 82, 84, 86 respectively. A valve 88 is positioned in the first duct 82 to direct the exhaust between reciprocating engine 20 to the chimney 60; or from the reciprocating engine 20 to the absorption chiller(s) 30. Additional valves 88 may be positioned in the second duct 84 to direct/restrict the flow of exhaust flue gas into the absorption chiller(s) 30.

It is to be appreciated that chimney 60 refers to any structure capable of providing ventilation for exhaust flue gas/smoke from the reciprocating engine(s) 20, absorption chiller(s) 30 to the outside surrounding or atmosphere. It may be made of different materials; for example bricks, metal etc. as long as the chimney 60 performs its desired function.

In addition, a portion of the exhaust ducting configuration 80 may be housed in one or more additional storey(s) between the second and third storey housing cooling towers, if required.

In operation, when the reciprocating engine 20 is in operation to power any equipment, flue exhaust from the reciprocating engine 20 is input into the absorption chiller 30 through the exhaust ducting configuration 80 via the valves 88. Any excess exhaust from the reciprocating engine 20 not directed into the absorption chiller 30 is directed to the chimney 60 having about 60 metres stack height (flue-gas stack) through the first duct 82. The stack height of the chimney 60 is determined depending on laws/regulation in different jurisdictions. For example, under Singapore's regulation, the stack height is required as a minimum of three metres above the highest point in the installed building or a minimum of three metres above the highest point corresponding to a highest building within a 100 metres radius, whichever is higher.

For each reciprocating engine 20, in addition to flue exhaust, high temperature water (utilized for cooling) may be directed through a heat exchanger to the absorption chiller 30 (hot water module). Together with the flue exhaust and hot water as inputs to the absorption chiller 30, bulk of the one thousand (1000) refrigeration tons for the absorption chiller 30 is produced. In circumstances where the exhaust and hot water are insufficient, each absorption chiller 30 may further be equipped with a direct fired (dual fuel) burner.

Alternatively, instead of a fuel combination of natural gas and diesel, the reciprocating engine 20 may be configured to operate using a full diesel mode, that is, using diesel as the only source of fuel. In such case, the exhaust flue will have to exhaust directly through its exhaust stack (via duct 82) to the chimney 60 as it is not suitable for use to drive the absorption chiller 30. In the full diesel mode operation, the reciprocating engine 20 provides hot water to the absorption chiller 30 but the balance cooling capacity will have to be made up by the absorption chiller's 30 own burners in full diesel mode. It is to be appreciated that the reciprocating engine 20 in full diesel mode is configured to be on a standby basis if natural gas is being disrupted. For example, if there is a natural gas feeding interruption. It is more economical and advantageous to operate with a combination of natural gas and diesel in terms of fuel and storage cost.

As another alternative, instead of a combination of natural gas and diesel, the reciprocating engine 20 may be configured to operate only in natural gas mode, that is, using natural gas as the only source of fuel. The exhaust flue from the full natural gas mode is most suitable for feeding into most, if not all absorption chillers 30.

In an embodiment, the dual fuel mode or bi-fuel mode operation comprises blending diesel fuel and natural gas in a combustion chamber of the reciprocating engine 20. The blend may be achieved by using a pilot-ignition, fumigated gas-charge design, whereby natural gas is pre-mixed with intake air of the reciprocating engine 20 and delivered to the combustion chamber via one or more air-intake valves. The pilot ignition mode is used to start the reciprocating engine 20; after which the bi-fuel mode is switched to a full natural gas mode (i.e. 100% natural gas operation). Such a switch from dual fuel/ bi-fuel mode in the starting or initial stage to a single fuel (i.e. natural gas) mode after pilot-ignition achieves a desired level of cost efficiency in the ignition stage as natural gas generally costs more than diesel.

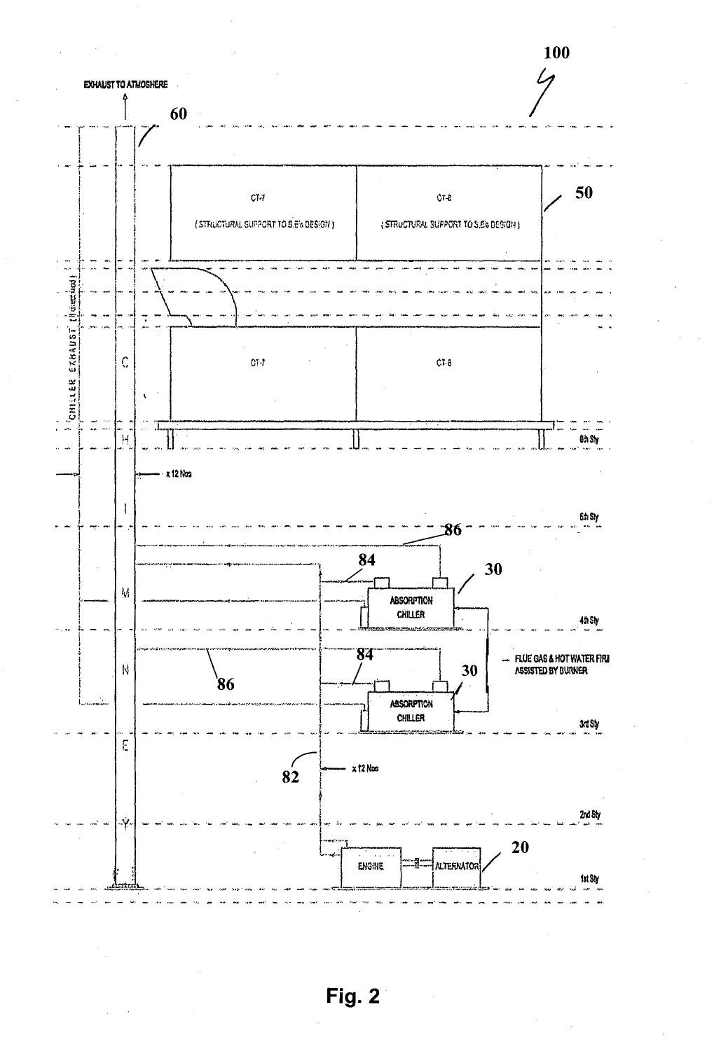

In accordance with another embodiment of the invention, where like reference numerals designate like parts, and with reference to FIG. 2 there is a cogeneration plant unit 100. The cogeneration plant unit 100 comprises seven storeys.

As shown in FIG. 2, cogeneration plant unit 100 comprises a base storey housing power generation source 20; two storeys (3^{rd} and 4^{th} storeys) vertically arranged above the base storey; the two storeys (3^{rd} and 4^{th}) for housing absorption chillers 30, the absorption chillers 30 operable to be in fluid communication with the power generation source 20; a storey (7^{th} storey) vertically arranged above of the 3^{rd} and 4^{th} storeys for housing cooling towers 50; and

a chimney 60 arranged in fluid communication with the absorption chillers 30 to dissipate the exhaust of the absorption chillers and the power generation source 20.

The 2^{nd} storey comprises one or more muffler(s) 70 to reduce the noise level generated by the power generation source 20. The power generation source 20 may also be housed in an enclosed area (not shown) to further reduce noise and/or protect the power generation source against weather elements.

In such instance, the base storey is therefore at least partially enclosed. There comprise 5^{th} and 6^{th} storeys for housing the building main switchboard rooms, internal power sub-station and voltage transformers rooms where applicable.

The power generator 20 is a reciprocating (piston) engine. The reciprocating (piston) engine 20 may be driven in various modes corresponding to the usage of different types of fuel, such as diesel and/or natural gas. As an example, power generator 20 is a dual-fuel engine to be driven by a combination comprising primarily natural gas and a relatively small amount of diesel. Natural gas is deemed to be a preferred fuel over diesel because the exhaust generated is cleaner and hence better for use as input for the absorption chillers 30. Preferably, the combination of fuel comprises at least 90% of natural gas. Each reciprocating engine 20 is configured to have a net electrical output depending on the needs of the application. The reciprocating engine 20 is operable to be in fluid communication, and/or coupled with the two units of absorption chillers 30 for the transmission of exhaust flue gas from the reciprocating engine 20 to the absorption chillers 30.

Each absorption chiller 30 is operably configured to be activated primarily by exhaust (flue gas), and supplementarily activated by hot water. Each absorption chiller 30 has an operating refrigerating capacity of up to 1000 USRT (refrigeration ton).

The power generator 20 and absorption chillers 30 are connected via exhaust ducting configuration 80.

The exhaust ducting configuration 80 described in the earlier embodiment may be extended for two absorption chillers. In particular, the exhaust ducting configuration 80 comprises a first duct 82 connected to the reciprocating engine 20 at one end and to the chimney 60 at the other end. Instead of a single second duct 84, there are two second ducts 84, each comprising two parts, the first part extending from the first duct 82 at one end and into the input (for flue exhaust) of the absorption chiller 30; and the second part of the second duct 84 is jointed to the first part and connected to the chimney 60.

Two third ducts 86 connect the exhaust of each of the absorption chillers 30 to the chimney 60 for dissipation.

Valves 88 (not shown) are located in positions to direct/restrict the flow of fluid (including exhaust) in the first duct, second duct and third duct 82, 84, 86.

Similar valves 88 as described in the earlier embodiment may be positioned in the first duct 82 to direct the exhaust between reciprocating engine 20 to the chimney 60; or from the reciprocating engine 20 to the absorption chiller(s) 30.

It is to be appreciated that the efficiency of the reciprocating engine 20 at 50% load is 8 to 10% less than full load efficiency. Therefore the decrease of the efficiency is considerably small from full load to 50% load. As an example, if the efficiency of the reciprocating engine 20 at full load is 36.5%, it decreases by 3.65% (36.5×0.1=3.65%) at 50% load.

In addition the longevity of mechanical components as bearings, cylinders and piston rings becomes longer.

Whereas the efficiency measured via coefficient of performance (COP) of an absorption chiller 30 at 50% load is 4% more than at full load efficiency. As an example, at the full load efficiency of 0.77, at 50% the COP increases from 0.77 to 0.8.

Additional valves 88 may be positioned in the second duct 84 to direct/restrict the flow of exhaust flue gas into the absorption chiller(s) 30.

It is to be appreciated that chimney 60 refers to any structure capable of providing ventilation for exhaust flue gas/smoke from the reciprocating engine(s) 20, absorption chiller(s) 30 to the outside atmosphere. It may be made of different materials; for example bricks, metal etc. as long as it performs its desired function.

In operation, when the reciprocating engine 20 is in operation to power any equipment, flue exhaust from the reciprocating engine 20 is input into two absorption chillers 30 situated in level 3 and level 4 through the exhaust ducting configuration 80 via the valves 88. Any excess exhaust from the reciprocating engine 20 not exhausted into the absorption chillers 30 is directed to the chimney 60 having about 60 metres stack height (flue-gas stack). The stack height is determined depending on laws/regulation in different jurisdictions. For example, under Singapore's regulation, the stack height is required as a minimum of three metres above the highest point in the installed building or a minimum of three metres above the highest point corresponding to a highest building within a 100 metres radius, whichever is higher.

For each reciprocating engine 20, high temperature cooling water may be directed through a heat exchanger to the two absorption chillers (hot water module). Together with the flue exhaust and hot water as inputs to the absorption chillers 30, bulk of the 1000 refrigeration tons for each chiller is produced. In circumstance where the exhaust and hot water are insufficient, each chiller may further be equipped with a direct fired (dual fuel) burner.

Alternatively, instead of a combination of natural gas and diesel, the reciprocating engine 20 may be configured to operate only in diesel mode (100%). In such case, the exhaust flue will have to exhaust directly through its exhaust stack as it is not suitable for use to drive the absorption chillers 30. In the diesel mode operation, the reciprocating engine 20 still provides the hot water to the chillers but the balance cooling capacity have to be made up by the absorption chillers 30 own burners in diesel mode. It is to be appreciated that the reciprocating engine in full diesel mode is configured to be on a standby basis if natural gas is being disrupted. It is more economical and advantageous to operate in natural gas mode than in diesel mode in terms of fuel and storage cost.

As another alternative, instead of a combination of natural gas and diesel, the reciprocating engine 20 may be configured to operate only in natural gas mode.

In an embodiment, the dual fuel mode or bi-fuel mode operation comprises blending diesel fuel and natural gas in a combustion chamber of the reciprocating engine 20. The blend may be achieved by using a pilot-ignition, fumigated gas-charge design, whereby natural gas is pre-mixed with intake air of the reciprocating engine 20 and delivered to the combustion chamber via one or more air-intake valves. The pilot ignition mode is used to start the reciprocating engine 20; after which the bi-fuel mode is switched to a full natural gas mode (i.e. 100% natural gas operation). Such a switch from dual fuel/bi-fuel mode in the starting or initial stage to a single fuel (i.e. natural gas) mode after pilot-ignition achieves a desired level of cost efficiency in the ignition stage as natural gas generally costs more than diesel.

In another embodiment, the described cogeneration plant unit 100 in FIG. 2 having seven storeys is viewed as a basic configuration. For the purpose of powering and cooling a building of a larger size, the basic configuration described is extended to comprise six power generators 20 and twelve absorption chillers 30. The six reciprocating engines 20 are configured to produce a total of about 52 megawatts of electrical energy, and the absorption chillers about 12,000 Refrigeration tons (1000 Rtons×2 units per set×6 sets per module) of chilled water cooling capacity at 7 degrees Celsius supply and 12 degrees Celsius return.

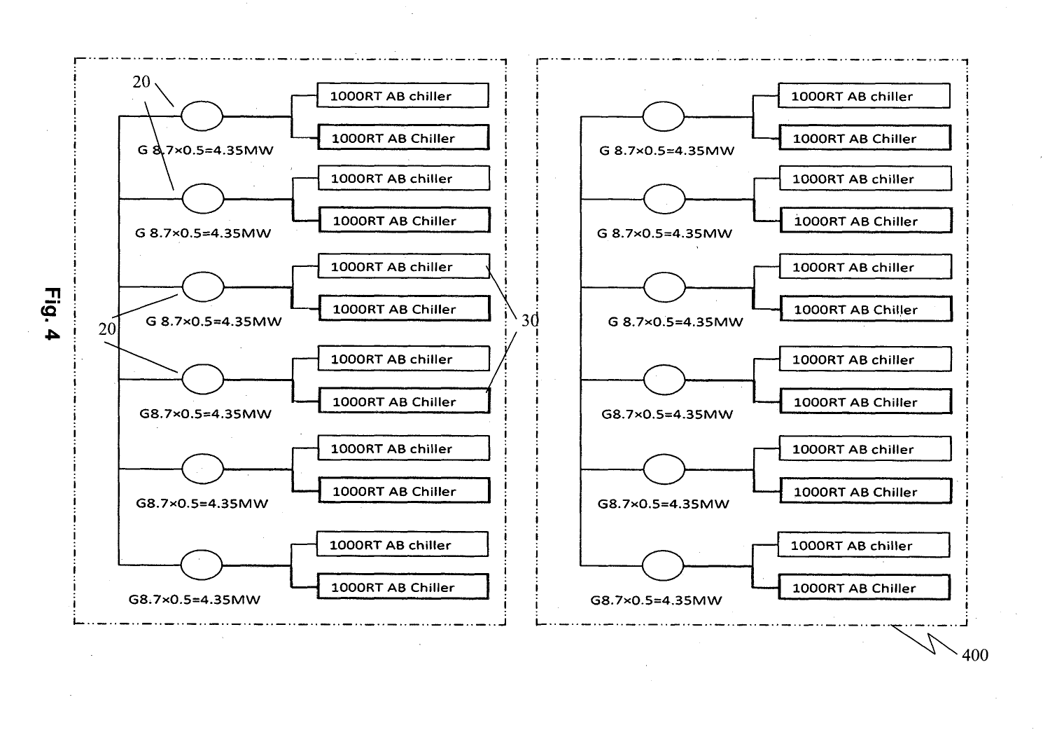

In another embodiment and as shown in FIG. 4, the described cogeneration plant unit 100 is viewed as a basic configuration. For the purpose of powering and cooling a data centre 400, and to meet the requirements for Tier 4 certification of the Uptime Institute, the described basic configuration is extended to comprise twelve units of dual fired engine generators 20 and twenty-four units of absorption chillers 30 as illustrated in FIG. 4. To meet the power requirements, each of the engine generators 20 operates at 50% load based on an example of 8.7 megawatts at 100% load, i.e. at 4.35 megawatts.

Thus twelve units of the dual fired engine generators 20 would produce approximately 52 Mega Watts load.

Based on the engine generators 20 operating load, each absorption chiller 30 may be configured to operate at 500 Refrigeration tons, thus producing a total of 12,000 Refrigeration tons. As an alternative and a more preferred configuration, to operate more economically, each engine exhaust and hot water from an engine generator 20 could be directed into one absorption chiller instead of two. At any one operating period, one absorption chiller is thus produce 1,000 Refrigeration tons. The other absorption chiller 30 functions as a form of back-up (providing redundancy) in case the operating absorption chiller 30 breaks down.

Reliability analysis had been carried out on the described data centre 400, in particular on the reliability of one unit of generator 20 coupled with two units of absorption chillers 30. The reliability analysis is based on the assumption that the reliability of the generator 20 R_{G} is 0.9 and the reliability for each absorption chiller R_{ab} is 0.8.

The reliability of each generator unit 20 with two absorption chillers R(unit) is calculated based on Equation (1):

$$\begin{matrix}R ( unit ) = {R}_{G} \times \{ 1 - ( 1 - {R}_{ab} ) ( 1 - {R}_{ab} ) \} \\ = 0.9 \times ( 1 - 0.2 \times 0.2 ) = 0.9 \times 0.96 = 0.864\end{matrix} \qquad ( 1 )$$

For the requirement of capacity as 52 mega watts load and 12000RT based on a 6-unit configuration, all 6 units must be in operation that is corresponding to a single system without redundancy.

Its reliability results in

R(6unit)=0.864⁶=0.415 (2)

Another reliability calculation is based on the assumption that for the data centre 400 comprising twelve units of generators 20, one generator unit 20 has failed.

The reliability of the system would be calculated based on the following probabilities:

Event A corresponding to all twelve generator units 20 in operation+Event B as 11 generator units run and one unit fails.

R(A)=0.9¹²=0.2824

Number of combination of Event B=nCr=12 (n=12,r=11)

R(B)=12×{0.9¹¹×(1−0.9)}=0.3766

R(A)+R(B)=0.2824+0.3766=0.659 (3)

Based on the earlier analysis in Equation (1) and substituting R(unit) as R(A),

Event A as all 12 units run +Event B as 11 units run and one unit fails.

Event R(A)=0.864¹²=0.1730

Number of combination of Event B=nCr=12 (n=12,r=11)

Event R(B)=12×{0.864¹¹×(1−0.864)}=0.3269

R(A)+R(B)=0.1730+0.3269=0.4999 (4)

In terms of compensating such failure, at least one of the eleven running units will be necessary for the increase from a 50% to 100% loading operation.

By using a vertical configuration, the cogeneration plant unit 10 may be implemented in areas where land are scarce (e.g. Singapore), while providing reliable requirements meeting Tier 4 of the Uptime Institute certification. The described embodiment also makes use of the thermodynamic concept of ‘hot air rises cool air sinks’ by having the absorption chillers 30 positioned above of the engine 20, so the hot flue exhaust of the engine 20 rises to power the absorption chillers 30 via the exhaust ducting configuration 80.

In addition to the vertical configuration, the adaption of the basic vertical configuration to power a data centre at a 50% load as described in the above embodiment is advantageous to meet the requirements for Tier 4 certification of the Uptime Institute and achieve physical space savings.

In the implementation of one or more of the embodiments of the vertical cogeneration plant, equipment weight and height considerations are taken account when deciding the height of each storey(s) and the load bearing capability. In particular, the reciprocating piston engine 20 is heavy and requires preferably an independent structural support when the plant 10, 400 is built. The independent structural support is separated from the rest of the building so that vibrations resulting from the operation of the reciprocating piston engines 20 are isolated from the rest of the plant.

It is to be understood that the above embodiments have been provided only by way of exemplification of this invention, and that further modifications and improvements thereto would be apparent to persons skilled in the relevant art and as such are deemed to fall within the broad scope and ambit of the present invention described, in particular:
Additional generators 20 and/or absorption chillers 30 may be added into the embodiments for redundancy.
Separate structural support may be built for the reciprocating engine 20 compared with the rest of the building.
While one possible ducting configuration 80 is described, other ducting configurations able to achieve the purpose of directing the exhaust flue to the chimney 60 and/or absorption chillers 30 are possible.

References to the terms ‘base’, ‘first’, ‘second’, ‘third’, ‘fourth’, ‘fifth’, storeys etc. in the described embodiments are terms used in the context for illustrating the order of the various elements housed within the cogeneration plant unit/plant. The reference is by no means restrictive and additional storeys may be added between the storeys as known by a person skilled in the art. In addition, it is appreciated that one or more storeys housing similar items may be combined into a single storey having a higher height than other storeys as required to meet height, regulatory or other requirements.

Furthermore although individual embodiments of the invention may have been described it is intended that the invention also covers combinations of the embodiments discussed.

1. A cogeneration plant unit comprising:
a base storey for housing a power generation source;
a second storey vertically arranged above the base storey for housing an absorption chiller, the absorption chiller operable to be in fluid communication with the power generation source;
a third storey vertically arranged above the second storey, the third storey for housing a cooling tower;
a chimney arranged in fluid communication with the power generation source and absorption chiller to dissipate the exhaust of the power generation source and the absorption chiller in operation; and
an exhaust ducting configuration capable of selectively directing the exhaust to the chimney or absorption chiller or in combination thereof allowing the flexibility to switch between modes.

2. The cogeneration plant unit according to claim 1, wherein the cogeneration plant unit comprises at least one additional storey vertically arranged above the second storey, each of the at least one additional storey for housing an absorption chiller.

3. A cogeneration plant unit according to claim 1, wherein the cogeneration plant unit comprises a muffler disposed between the base storey and the second storey for housing the absorption chiller(s).

4. The cogeneration plant unit according claim 1, wherein the cogeneration plant unit comprises at least one additional storey arranged between the storeys for housing absorption chillers and the third storey, the at least one additional storey for housing electrical components.

5. The cogeneration plant unit according to claim 1, wherein the power generation source is a dual-fuel reciprocating (piston) engine operable in a mode driven by a combination of natural gas and diesel.

6. The cogeneration plant unit according to claim 5, wherein the combination of natural gas and diesel comprises at least 90% natural gas.

7. The cogeneration plant unit according to claim 5, wherein in operation the combination of natural gas and diesel is utilized for a pilot-ignition of the power generation source, and thereafter natural gas is utilized as the single fuel for power generation.

8. The cogeneration plant unit according to claim 1, wherein the absorption chiller is activated by an input of exhaust (flue gas), and supplemented by hot water.

9. The cogeneration plant operable to power a data centre, the cogeneration plant comprising a cogeneration plant unit of claim 1, having twelve power generation sources and twenty four absorption chillers.

10. The cogeneration plant according to 9, wherein each power generation source is a reciprocating (piston) engine having a maximum load capacity of 8.7 megawatts and operable to produce an output at 50% load.

11. The cogeneration plant according to claim 10, wherein each absorption chiller operates to produce 500 refrigeration tons.

12. The cogeneration plant according to claim 9, wherein twelve of the twenty four absorption chillers are operable each to produce 1000 refrigeration tons and the remaining twelve absorption chillers are not in operation or in stand-by mode.

13. A cogeneration plant unit comprising:
a base storey for housing a power generation source;
a second storey vertically arranged above the base storey for housing an absorption chiller, the absorption chiller operable to be in fluid communication with the power generation source;
a third storey vertically arranged above the second storey, the third storey for housing a cooling tower;
a chimney arranged in fluid communication with the power generation source and absorption chiller to dissipate the exhaust of the power generation source and the ab sorption chiller in operation; and
an exhaust ducting configuration; wherein the exhaust ducting configuration connects the power generation source, chimney and the absorption chiller.
